(19) United States
(12) Patent Application Publication
(10) Pub. No.: US 2026/0143379 A1
(43) Pub. Date: May 21, 2026

(54) MULTI-LINK OPERATION TRANSMISSION SYSTEM AND MULTI-LINK OPERATION TRANSMISSION METHOD

(71) Applicant: REALTEK SEMICONDUCTOR CORPORATION, HSINCHU (TW)

(72) Inventor: JHE-YI LIN, Hsinchu (TW)

(21) Appl. No.: 19/372,632

(22) Filed: Oct. 29, 2025

(30) Foreign Application Priority Data
Nov. 1, 2024 (TW) 113142021

(51) Int. Cl. H04W 28/02; H04B 7/06; H04L 43/0823

(52) U.S. Cl. CPC H04W 28/0268; H04B 7/0626; H04L 43/0847

(57) ABSTRACT

A multi-link operation transmission system includes a transmission information device, a reinforcement learning device, and a feedback device. The transmission information device is configured to transmit a plurality of packages to a receiving device with an initial transmission state through a plurality of channels. The feedback device is configured to feed back the initial transmission state and a transmission result. The reinforcement learning device is configured to provide a transmission rate to the transmission information device according to the initial transmission state and the transmission result provided by the feedback device such that the transmission rate of the transmission information device conforms to the plurality of channels.

### BACKGROUND OF THE INVENTION

### 1. Field of the Invention

The present disclosure relates to a multi-link operation transmission system and a multi-link operation transmission method, especially to a multi-link operation transmission system and a multi-link operation transmission method for adjusting a transmission rate of information transmission operation by using a reinforcement learning device.

### 2. Description of Related Art

Multi-link operation (MLO) is a wireless communication technology aimed at utilizing multiple wireless connections simultaneously to provide higher performance and reliability. However, since most packages are transmitted through the primary transmission link, the opportunity for non-primary transmission links to perform package transmission is significantly limited. As a result, the rate adaptation (RA) algorithm lacks sufficient information to adjust the transmission rate (TX Rate), such that the transmission rate does not accurately reflect the current channel state and quality. This situation substantially increases the probability of transmission failure and degrades the user's quality of experience (QoE).

### SUMMARY OF THE INVENTION

In some aspects, an object of the present disclosure is to, but not limited to, provides a multi-link operation transmission system and a multi-link operation transmission method that makes an improvement to the prior art.

An embodiment of the multi-link operation transmission system of the present disclosure includes a transmission information device, a reinforcement learning device, and a feedback device. The transmission information device is configured to transmit a plurality of packages to a receiving device with an initial transmission state through a plurality of channels. The feedback device is configured to feed back the initial transmission state and a transmission result. The reinforcement learning device is configured to provide a transmission rate to the transmission information device according to the initial transmission state and the transmission result provided by the feedback device, such that the transmission rate of the transmission information device conforms to the plurality of channels.

An embodiment of the multi-link operation transmission method of the present disclosure includes following steps: transmitting a plurality of packages to a receiving terminal with an initial transmission state through a plurality of channels by a transmission information device; feeding back the initial transmission state and a transmission result by a feedback device; and providing a transmission rate to the transmission information device by a reinforcement learning device according to the initial transmission state and the transmission result provided by the feedback device, such that the transmission rate of the transmission information device conforms to the plurality of channels.

Technical features of some embodiments of the present disclosure make an improvement to the prior art. The multi-link operation transmission system and the multi-link operation transmission method of the present disclosure can adaptively adjust the transmission rate of the transmission information device, such that the transmission rate of the transmission information device conforms to the channel conditions, thereby significantly reducing the probability of transmission failure and enhancing the user's quality of experience (QoE).

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1A shows an embodiment of a multi-link operation transmission network of the present disclosure.

FIG. 1B shows an embodiment of a multi-link operation transmission system of the present disclosure.

FIG. 2 shows an embodiment a flowchart of a multi-link operation transmission method of the present disclosure.

FIG. 3 shows an embodiment of a multi-link operation transmission system of the present disclosure.

### DETAILED DESCRIPTION OF THE PREFERRED EMBODIMENTS

To address the issue in the prior art in which the transmission failure rate of non-primary transmission links in multi-link devices is relatively high, the present disclosure provides a multi-link operation transmission system and a multi-link operation transmission method, which will be explained in detail as shown below.

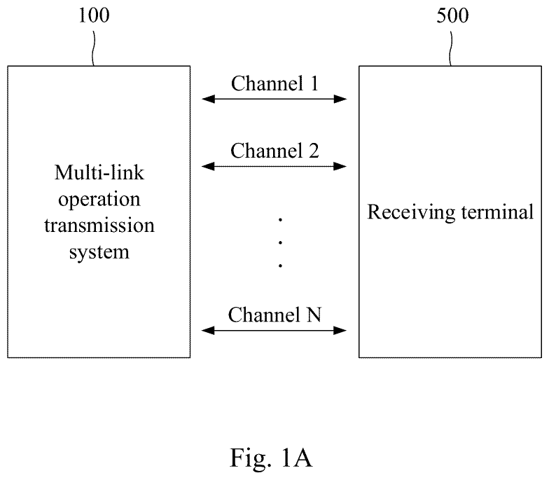

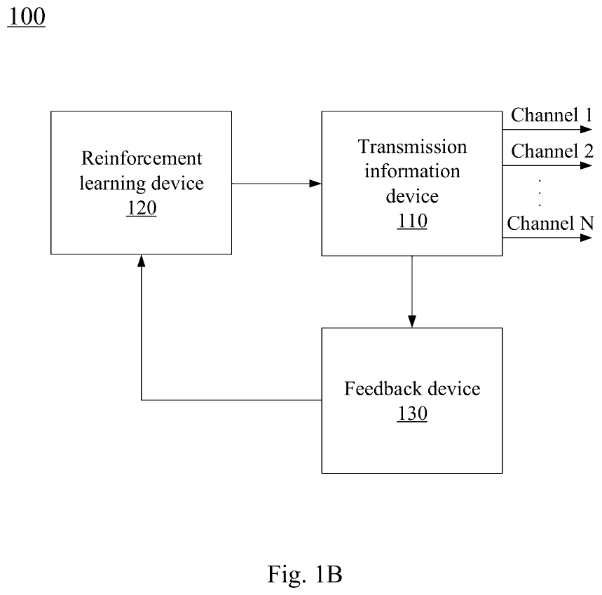

FIG. 1A shows an embodiment of a multi-link operation transmission network of the present disclosure. FIG. 1B shows an embodiment of a multi-link operation transmission system 100 of the present disclosure. As shown in FIG. 1B, the multi-link operation transmission system 100 includes a transmission information device 110, a reinforcement learning device 120, and a feedback device 130.

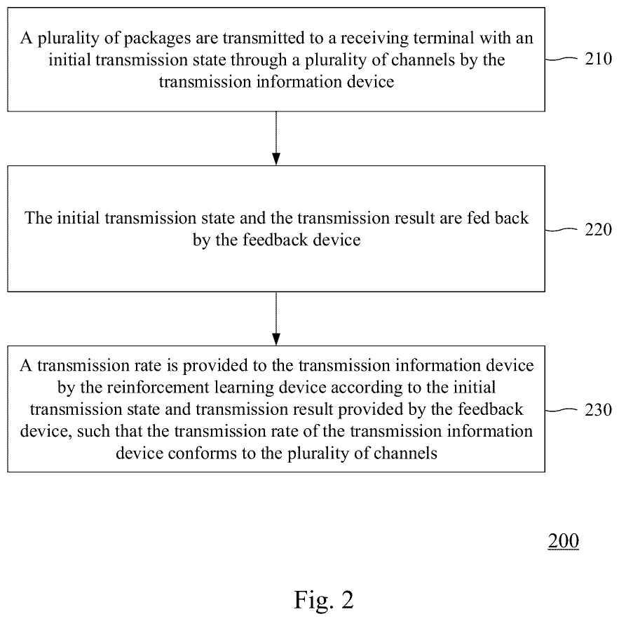

To facilitate understanding of the operation of the multi-link operation transmission system 100, please also refer to FIG. 2, which shows an embodiment a flowchart of a multi-link operation transmission method 200 of the present disclosure.

In step 210, a plurality of packages are transmitted to a receiving terminal 500 with an initial transmission state through a plurality of channels 1 to N by the transmission information device 110. For example, the initial transmission state of the transmission information device 110 includes an initial transmission rate, a channel type, and channel state information (CSI).

In some embodiments, the transmission information device 110 outputs the initial transmission rate through a rate adjustment mechanism (e.g., rate adaptation, RA). In some embodiments, the channel type may be a cable link, an open space, a work space, etc. For example, the open space may be a parking lot, and the work space may be an indoor office. The present disclosure may perform adaptive evaluation on the channels 1 to N based on the different types.

In step 220, the initial transmission state and the transmission result are fed back by the feedback device 130. In step 230, a transmission rate is provided to the transmission information device 110 by the reinforcement learning device 120 according to the initial transmission state and transmission result provided by the feedback device 130, such that the transmission rate of the transmission information device 110 conforms to the plurality of channels 1 to N. For example, the reinforcement learning device 120 may provide an optimal transmission rate to the transmission information device 110 based on the initial transmission rate, the channel type, and the channel state information contained in the initial transmission state, as well as the aforementioned transmission result, such that the transmission rate of the transmission information device 110 conforms to the plurality of channels 1 to N.

In view of the above, the present disclosure provides the multi-link operation transmission system 100 with the reinforcement learning device 120, which can modify the initial transmission rate output from the rate adjustment mechanism (e.g., rate adaptation, RA), and output a more appropriate transmission rate (e.g., TX rate). When transmission is performed via non-primary channels, the transmission rate may be unreliable if the system uses the rate adjustment mechanism (RA) to directly determine the transmission rate (e.g., TX rate). The present disclosure provides adding the reinforcement learning device 120 (e.g., a reinforcement learning critic) after the rate adjustment mechanism (RA) when performing multi-link operation (MLO), to evaluate the reliability of the current transmission rate (e.g., TX rate), and determine the most suitable transmission rate.

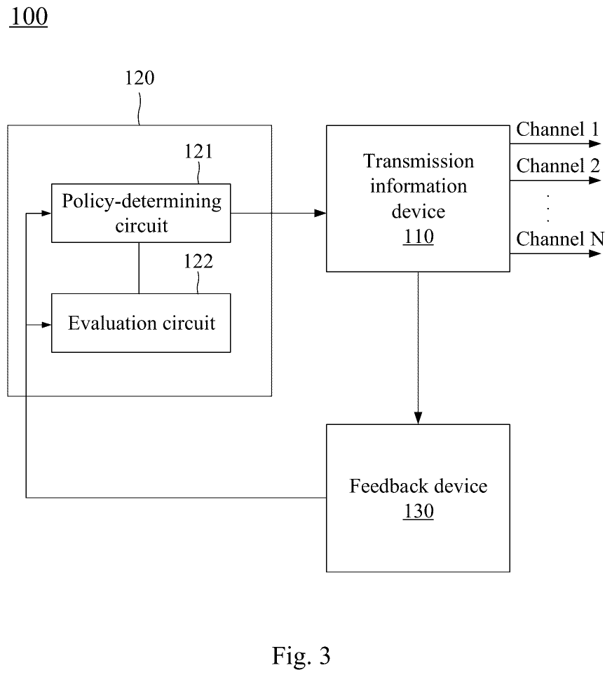

FIG. 3 shows an embodiment of the multi-link operation transmission system 100 illustrated in FIG. 1 of the present disclosure. As shown in the figure, the reinforcement learning device 120 includes a policy-determining circuit 121 and an evaluation circuit 122. The policy-determining circuit 121 is configured to determine a transmission policy according to the initial transmission state and an age of information, and to control the transmission information device 110 to transmit a plurality of packages to the receiving terminal 500 according to the transmission policy. Subsequently, the feedback device 130 feeds back the transmission result to the evaluation circuit 122 according to the transmission status of the packages transmitted by the transmission information device 110 to the receiving terminal 500. Then, the evaluation circuit 122 is configured to perform a reliability evaluation on the transmission result, and to adjust the transmission rate of the packages transmitted by the transmission information device 110 to the receiving terminal 500 according to an evaluation result of the reliability evaluation.

Accordingly, the present disclosure utilizes the policy-determining circuit 121 and the evaluation circuit 122 of the reinforcement learning device 120 to interact with the transmission environment and learn better decision-making capabilities. For example, the present disclosure can determine a transmission policy and perform a reliability evaluation on the result of the transmission policy to adaptively modify the transmission policy, thereby solving the problem of unreliable transmission rates on non-primary transmission links in multi-link applications.

In some embodiments, the evaluation circuit 122 calculates an error rate (e.g., package error rate) according to a transmission failure result and a transmission success result of the transmission result, and the error rate serves as a basis for reliability evaluation. In some embodiments, in the field of reinforcement learning, the policy-determining circuit 121 may function as a policy determiner (e.g., Actor), and the evaluation circuit 122 may function as an evaluator (e.g., Critic). Through the collaborative operation between the policy determiner (e.g., Actor) and the evaluator (e.g., Critic), the present disclosure can achieve a more robust learning state. Specifically, the policy determiner (e.g., Actor) is a neural network or another learning model used to learn and determine a policy. The evaluator (e.g., Critic) is a neural network or another learning model used to estimate the value of a state or a state-action pair. The goal of the policy determiner-evaluator (e.g., Actor-Critic) mechanism is to minimize both the error rate (e.g., package error rate) and the difference between the predictions of the policy determiner (e.g., Actor) and the evaluator (e.g., Critic). This enables the policy determiner (e.g., Actor) and the evaluator (e.g., Critic) to cooperate and complement each other, thereby improving the efficiency and stability of learning.

It is noted that the present disclosure is not limited to the embodiments as shown in FIG. 1A to FIG. 3, they are merely examples for illustrating the implements of the present disclosure, and the scope of the present disclosure shall be defined on the basis of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The multi-link operation transmission system and the multi-link operation transmission method of the present disclosure can adaptively adjust the transmission rate of the transmission information device, such that the transmission rate of the transmission information device conforms to the channel, significantly reducing the probability of transmission failure and improving the user's quality of experience (QoE).

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A multi-link operation transmission system, comprising:
a transmission information device, configured to transmit a plurality of packages to a receiving terminal with an initial transmission state through a plurality of channels;
a feedback device, configured to feed back the initial transmission state and a transmission result; and
a reinforcement learning device, configured to provide a transmission rate to the transmission information device according to the initial transmission state and the transmission result provided by the feedback device, such that the transmission rate of the transmission information device conforms to the plurality of channels.

2. The multi-link operation transmission system of claim 1, wherein the initial transmission state comprises one of an initial transmission rate, a channel type, and a channel state information.

3. The multi-link operation transmission system of claim 2, wherein the transmission information device outputs the initial transmission rate through a rate adjustment mechanism.

4. The multi-link operation transmission system of claim 1, wherein the reinforcement learning device comprises:
a policy-determining circuit, configured to determine a transmission policy according to the initial transmission state and an age of information, and control the transmission information device to transmit the plurality of packages to the receiving terminal according to the transmission policy; and
an evaluation circuit, configured to perform a reliability evaluation on the transmission result, and adjust the transmission rate of the transmission information device according to an evaluation result of the reliability evaluation.

5. The multi-link operation transmission system of claim 4, wherein the evaluation circuit calculates an error rate according to a transmission failure result and a transmission success result of the transmission result, such that the error rate serves as a basis of the reliability evaluation.

6. A multi-link operation transmission method, comprising:
transmitting a plurality of packages to a receiving terminal with an initial transmission state through a plurality of channels by a transmission information device;
feeding back the initial transmission state and a transmission result by a feedback device; and
providing a transmission rate to the transmission information device by a reinforcement learning device according to the initial transmission state and the transmission result provided by the feedback device, such that the transmission rate of the transmission information device conforms to the plurality of channels.

7. The multi-link operation transmission method of claim 6, wherein the initial transmission state comprises one of an initial transmission rate, a channel type, and a channel state information.

8. The multi-link operation transmission method of claim 7, wherein the transmission information device outputs the initial transmission rate through a rate adjustment mechanism.

9. The multi-link operation transmission method of claim 6, wherein providing the transmission rate to the transmission information device by the reinforcement learning device according to the initial transmission state and the transmission result provided by the feedback device comprises:
determining a transmission policy according to the initial transmission state and an age of information, and controlling the transmission information device to transmit the plurality of packages to the receiving terminal according to the transmission policy by a policy-determining circuit of the reinforcement learning device; and
performing a reliability evaluation on the transmission result, and adjusting the transmission rate of the transmission information device according to an evaluation result of the reliability evaluation by an evaluation circuit of the reinforcement learning device.

10. The multi-link operation transmission method of claim 9, wherein performing the reliability evaluation on the transmission result by the evaluation circuit of the reinforcement learning device comprises:
calculating an error rate according to a transmission failure result and a transmission success result of the transmission result by the evaluation circuit, such that the error rate serves as a basis of the reliability evaluation.
